(19) United States
(12) Patent Application Publication
(10) Pub. No.: US 2025/0346794 A1
(43) Pub. Date: Nov. 13, 2025

(54) ANTIFREEZE CONCENTRATE WITH CORROSION PROTECTION AND AQUEOUS COOLANT COMPOSITION PRODUCED THEREFROM

(71) Applicant: BASF SE, Ludwigshafen Am Rhein (DE)

(72) Inventors: Masayuki Hirosue, Ludwigshafen (DE); Itamar Michael Malkowsky, Ludwigshafen (DE); Uwe Nitzschke, Ludwigshafen (DE); Nina Schindler, Ludwigshafen (DE)

(73) Assignee: BASF SE, Ludwigshafen Am Rhein (DE)

(21) Appl. No.: 18/715,936

(22) PCT Filed: Nov. 29, 2022
(86) PCT No.: PCT/EP2022/083648

§ 371 Date: Jun. 3, 2024

(30) Foreign Application Priority Data
Dec. 9, 2021 (EP) 21213282.3

(51) Int. Cl. C09K 5/20; C23F 11/12; C23F 11/16; C23F 11/18

(52) U.S. Cl. CPC C09K 5/20; C23F 11/124; C23F 11/165; C23F 11/188

(57) ABSTRACT

An antifreeze concentrate is based on freezing point-lowering liquids as main constituent, sulfur-comprising organic compounds as corrosion inhibitors and further corrosion inhibitors which are different therefrom. This antifreeze concentrate is suitable for coolants, for example for internal combustion engines, and for heat transfer fluids. Further an aqueous coolant composition is produced from the antifreeze concentrate showing cooling properties of this aqueous composition for an internal combustion engine whose cooling apparatus has been made from aluminum by soldering using a fluoroaluminate flux. Sulfuric organic compounds act as corrosion inhibitors in such antifreeze concentrates and aqueous coolant compositions in general.

### CROSS-REFERENCE TO RELATED APPLICATIONS

This application is a National Stage entry under $371 of International Application No. PCT/EP2022/083648, filed on Nov. 29, 2022, and which claims the benefit of priority to European Patent Application No. 21213282.3, filed on Dec. 9, 2021. The content of each of these applications is hereby incorporated by reference in its entirety.

### DESCRIPTION

The present invention relates to a novel antifreeze concentrate based on freezing point-lowering liquids as main constituent, specific sulfur-comprising organic compounds as corrosion inhibitors and also further corrosion inhibitors which are different therefrom. This antifreeze concentrate is suitable for coolants, for example for internal combustion engines and electrified vehicles, and for heat transfer fluids. The present invention further relates to an aqueous coolant composition produced therefrom. The present invention further relates to the use of this aqueous coolant composition for cooling an internal combustion engine, electric engine, battery, or power electronics whose cooling apparatus has been made from aluminum by soldering using a fluoroaluminate flux. The present invention further relates to the use of particular sulfur-comprising organic compounds as corrosion inhibitors in such antifreeze concentrates and aqueous coolant compositions in general.

Coolant compositions for the cooling apparatuses (which are usually configured as cooling circuits) of internal combustion engines, electric engines, batteries, and power electronics of, for example, automobiles usually comprise alkylene glycols such as monoethylene glycol or monopropylene glycol, optionally in admixture with glycerol, as antifreeze component which lowers the freezing point of the coolant composition. Apart from further components such as antifoams, dyes or bitter substances, corrosion inhibitors, in particular, are comprised.

Especially in modern internal combustion engines, temperatures which place severe demands on the materials used are reached. Any type and any extent of corrosion represent a potential risk factor which can lead to shortening of the life of the engine and to a decrease in reliability. Furthermore, a number of different materials, for example cast iron, copper, brass, soft solder, steel and also aluminum, aluminum alloys and magnesium alloys, are increasingly being used in modern engines and components in electrified vehicles. This plurality of metallic materials additionally results in potential corrosion problems, in particular at the places where different metals are in contact with one another. Various types of corrosion such as pit corrosion, crevice corrosion, erosion or cavitation can occur comparatively easily at such places in particular. The coolant compositions likewise have to be compatible with nonmetallic constituents of the cooling apparatuses, for example elastomers and plastics from hose connections or seals, and must not change these. Furthermore, the type of coolant composition is of critical importance for heat transfer in modern internal combustion engines.

For some time, the cooling apparatus or cooling circuits for internal combustion engines which are usually used in vehicle and automobile construction but also for stationary engines have been made predominantly or solely of aluminum or aluminum alloys. The same applies to electrified vehicles. Specific soldering processes, for example soldering under a protective gas atmosphere, are used here. In such soldering processes, the concomitant use of a flux is necessary. Here, potassium fluoroaluminates are usually used as flux, for example a mixture of KAlF₄, K₂AlF₅ and K₃AlF₆ (for example commercially available under the name Nocolok®). The general formula is KₓA_{y}lF_{z} with the proviso that (x+(3*y))=z, wherein x, y, and z are natural numbers, y being 1 or 2, preferably 1, x being 1 to 6, preferably 1, 2 or 3, and z being 4 to 12, preferably 4, 5 or 6.

Part of the fluxes mentioned remains on the surface of the cooling apparatus after the soldering operation. These flux residues in the cooling apparatus lead more or less quickly to precipitation of aluminum hydroxide gels and thus to sludge formation in the cooling circuit after introduction of aqueous coolant compositions and operation of the engine due to a chain of chemical reactions, which are in equilibrium with one another, with the water and the constituents of the aqueous coolant compositions. This greatly restricts the effectiveness of heat removal from the engine and as a consequence also the functions of the heat exchange for the heating system, cooling of the air supply and gearbox oil cooling. In addition, the presence of aluminum hydroxide gels has an adverse effect on the corrosion protection provided by the coolant because the corrosion protection action is considerably reduced as a result of adsorption of the corrosion inhibitors on the aluminum hydroxide gels.

WO 2009/111443 A2 discloses heat transfer fluids based on alcohols which can be used in heat exchanger apparatuses which contain aluminum components soldered using potassium fluoroaluminate fluxes. For these heat transfer fluids, an entire series of possible individual corrosion inhibitors which are inorganic or organic in nature, e.g. molybdates, tungstates, vanadates, phosphates, antimonates, nitrates, nitrites, borates, azoles or carboxylates, are recommended. 2-Mercaptobenzothiazole (MTB) is mentioned as a sulfur-comprising azole which can be used. Table 1 shows, as base coolant concentrate, a formulation (I) based on monoethylene glycol and comprising >94% by weight of ethylene glycol, 0.1-0.3% by weight of tolyltriazole, 0.2-0.5% by weight of nitrate, 0.04-0.1% by weight of molybdate, 0.1-2.0% by weight of borax, 0.1-0.5% by weight of phosphoric acid, <0.3% by weight of MBT, 0.1-0.5% by weight of silicate and 0.4-2.0% by weight of NaOH/KOH, where MBT could but does not necessarily have to be mercaptobenzothiazole since no explanation of MBT is given.

Except for WO 2014/124826 (see below), no adequate coolant composition with corrosion protection for internal combustion engines, electric engines, batteries, and power electronics, which actually meet the requirements in respect of increased flux tolerance when used in aluminum cooling apparatuses soldered using the abovementioned fluxes, have been found to date. It was therefore an object of the invention to provide an antifreeze concentrate with corrosion protection from which it is possible to obtain an aqueous coolant composition which has a high tolerance to residues of fluoroaluminate fluxes in soldered aluminum radiators, i.e. which no longer tends, or tends to a significantly less extent, to form precipitates of aluminum hydroxide gels and formation of sludge in the cooling circuit and thus makes more effective corrosion protection possible.

In WO 2014/124826 coolants are disclosed which comprise freezing point-lowering alcohols, a (2-benzothiazylthio)-carboxylic acid, phosphates, organic carboxylic acids, and molybdates as constituents.

The anticorrosion activity of the coolants according to WO 14/124826 is good, however, the coolants mandatorily comprise molybdates which is discouraged in modern coolants, since the presence of heavy metals makes the disposal of such compositions difficult. Heavy metal-containing coolants need to be collected separately and due to the presence of molybdates are to be handled as special waste.

Therefore, a need exists for heavy metal-free coolants which exhibit a comparable or even better anti-corrosion performance and flux tolerance than the coolants according to WO 14/124826.

We have accordingly found an antifreeze concentrate with corrosion protection, which comprises
(A) at least one freezing point-lowering liquid selected from among monohydric, dihydric and trihydric alcohols, polyhydroxy alcohols, their ethers and mixtures thereof as main constituent;
(B) at least one 2-thiothiazole of the general formula I

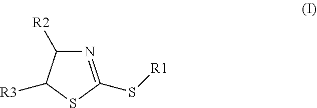

where the variable R1 is hydrogen or preferably a carboxyalkyl radical of the formula (CₘH₂ₘ)—COOX, where m is from 1 to 4 and X is hydrogen, an alkali metal cation, an ammonium cation or a substituted ammonium cation, and the variables R2 and R3 are each, independently of one another, hydrogen or a C₁-C₄-alkyl group, where R2 and R3 together with the two ring carbon atoms of the thiazole ring to which they are attached may also form a five- or six-membered saturated or unsaturated ring as corrosion inhibitor;
(C) at least one inorganic nitrate salt as further corrosion inhibitor;
(D) at least one inorganic phosphate salt as further corrosion inhibitor;
(E) at least one aliphatic, cycloaliphatic or aromatic monocarboxylic, dicarboxylic or tricarboxylic acid in the form of alkali metal, ammonium or substituted ammonium salts thereof having from 3 to 21 carbon atoms in the acid part,
   with the proviso that metals having a density of 5 g/cm³ or more in metallic or cationic form are present in the compositions in amounts of not more than 200 ppm by weight for each metal,
   wherein component (B) is (2-benzothiazylthio) acetic acid, 3-(2-benzothiazylthio) propionic acid or an alkali metal, ammonium or substituted ammonium salt thereof.

The antifreeze concentrates according to the invention are coolants prepared from those concentrates exhibit an anti-corrosion activity at least comparable to the compositions according to WO 14/124826 and additionally exhibit a higher stability against oxidation, e.g by oxygen-containing gases.

The antifreeze component (A), which represents the main constituent of the antifreeze concentrate of the invention and therefore generally makes up more than 50% by weight of the concentrate, ensures problem-free starting of the engine when the internal combustion engine having a coolant composition produced therefrom is started in an environment significantly below 0° C. and then good flow behavior and good heat removal during operation of the engine. Suitable monohydric, dihydric or trihydric alcohols, polyhydroxy alcohols and their ethers for the component (A) are, for example, methanol, ethanol, n-propanol and isopropanol, n-butanol, isobutanol and sec-butanol, furfurol, tetrahydrofurfuryl alcohol, ethoxylated furfuryl alcohol, alkoxyalkanols such as methoxyethanol, monoethylene glycol, monopropylene glycol, diethylene glycol, dipropylene glycol, triethylene glycol, tripropylene glycol, tetraethylene glycol, tetrapropylene glycol, pentaethylene glycol, pentapropylene glycol, hexaethylene glycol, hexapropylene glycol, glycerol, sorbitol, mannitol, diglycerol, threitol, erythritol, adonitol (ribitol), arabitol (lyxitol), xylitol, dulcitol (galactitol), maltitol, isomaltitol, 1,2,6-hexanetriol, trimethylolpropane, trimethylolethane, pentaerythritol, and also monoethers of glycols such as methyl, ethyl, propyl and butyl ethers, with n-butyl ethers being preferred among these, of monoethylene glycol, monopropylene glycol, diethylene glycol and dipropylene glycol. Of course, mixtures of the alcohols, polyhydroxy alcohols and ethers mentioned can also be used. For the purposes of the present invention, the term propylene glycol encompasses both 1,2-propanediol and 1,3-propanediol.

In a preferred embodiment, the antifreeze concentrate with corrosion protection according to the invention comprises, as freezing point-lowering liquid (A), monoethylene glycol, monopropylene glycol or mixtures of monoethylene glycol or monopropylene glycol with up to 35% by weight of glycerol, in each case based on the total amount of freezing point-lowering liquid. Very particular preference is given to using monoethylene glycol without 5 additions of other alcohols or ethers.

In a particularly preferred embodiment, the antifreeze concentrate with corrosion protection of the invention comprises at least one 2·thiothiazole of the general formula I

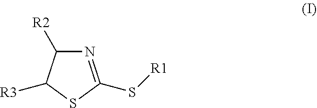

where the variable R1 is hydrogen or preferably a carboxyalkyl radical of the formula —(CₘH₂ₘ)—COOX, where m is from 1 to 4 and X is hydrogen, an alkali metal cation, an ammonium cation or a substituted ammonium cation, and the variables R2 and R3 are each, independently of one another, hydrogen or a C₁-C₄-alkyl group, where R2 and R3 together with the two ring carbon atoms of the thiazole ring to which they are attached may also form a five- or six-membered saturated or unsaturated ring, as corrosion inhibitor (B1) or (B2).

The C₁-C₄-alkylene radical in the variable R1 can be a branched group such as 1,2-propylene, 1,2-butylene or 2,3-butylene or a linear polymethylene group. R1 is preferably a radical of the formula —(CH₂)ₘ—COOX, where m is 1, 2, 3 or 4, preferably 2 or 3. Preferably-(CₘH₂ₘ)— is 1,2-ethylene or 1,3-propylene.

If one or both of the variables R2 and R3 are C₁-C₄-alkyl groups, such alkyl groups are usually selected from among methyl, ethyl, n-propyl, isopropyl, n-butyl, isobutyl, sec-butyl and tert-butyl. In particular. R2 and R3 are both hydrogen or one of these variables is hydrogen and the other is methyl or ethyl or the two variables R2 and R3 together with the two ring carbon atoms of the thiazole ring to which they are attached form a benzene ring (benzo-fused ring systems).

If the variable X is an alkali metal cation, it is, for example, lithium or preferably sodium or potassium. If the variable X is an unsubstituted ammonium cation, this is derived from ammonia (NH₃). If the variable X is a substituted ammonium cation, this is derived, for example, from monoalkylamines, dialkylamines or trialkylamines such as monoethylamine, diethylamine or triethylamine or from trialkanolamines such as triethanolamine or triisopropanolamine.

According to the present invention corrosion inhibitors (B) are (2-benzothiazylthio) acetic acid, 3-(2-benzothiazylthio) propionic acid or an alkali metal, ammonium or substituted ammonium salt thereof. The two corrosion inhibitors mentioned are commercially available under the name Sanbit® ABT and Danbit® PBT (manufacturer: Sanshin Chemical Industry).

As corrosion inhibitor (C), it is usual to use the (earth) alkali metal, ammonium or substituted ammonium salts of nitric acid (HNO₃). Preferred are alkali metal nitrates and earth alkali metal nitrates, more preferably alkali metal nitrates. Very preferred are sodium nitrate and potassium nitrate, especially sodium nitrate.

As corrosion inhibitor (D), it is usual to use the alkali metal, ammonium or substituted ammonium salts of orthophosphoric acid H₃PO₄ or the acid itself, where alkali metal, ammonium or substituted ammonium salts have the meanings indicated above. However, the component (D) will generally be present entirely or predominantly in salt form in the concentrate of the invention which normally has a pH of from 4 to 11, in particular from 7 to 11. When free orthophosphoric acid is used, this is usually converted by means of sodium or potassium hydroxide, ammonia or appropriate amines into the desired salts. Further suitable components (D) are alkali metal, ammonium or substituted ammonium salts of diphosphoric acid, of metaphosphoric acids, of pyrophosphoric acids and/or of polyphosphoric acids or the acids themselves, where alkali metal, ammonium or substituted ammonium salts have the meanings indicated above. It is also possible to use mixtures of the salts and/or acids mentioned. Typical representatives of such phosphates (D) are sodium dihydrogenphosphate, disodium hydrogenphosphate, trisodium phosphate, sodium diphosphate, tetrasodium pyrophosphate, sodium tripolyphosphate, sodium hexametaphosphate and the analogous potassium salts.

Possible corrosion inhibitors (E) are, in particular, individual representatives or mixtures of such representatives from the following groups of carboxylic acids:
(E1) aliphatic, cycloaliphatic or aromatic, preferably aliphatic or aromatic, and very preferably aliphatic monocarboxylic acids having in each case from 3 to 16 carbon atoms in the form of their alkali metal, ammonium or substituted ammonium salts;
(E2) aliphatic or aromatic dicarboxylic or tricarboxylic acids, preferably dicarboxylic acids having in each case from 3 to 21 carbon atoms in the form of their alkali metal, ammonium or substituted ammonium salts.

Possible linear or branched aliphatic or cycloaliphatic, preferably aliphatic monocarboxylic acids of group (E1) are, for example, propionic acid, pentanoic acid, hexanoic acid, cyclohexylacetic acid, octanoic acid, 2-ethylhexanoic acid, nonanoic acid, isononanoic acid, decanoic acid, neodecanoic acid, undecanoic acid or dodecanoic acid. Suitable aromatic monocarboxylic acids of group (E1) are in particular benzoic acid and also, for example, C₁-C₈-alkylbenzoic acids such as o-, m- or p-methylbenzoic acid or p-tert-butylbenzoic acid, hydroxyl-comprising aromatic monocarboxylic acids such as o-, m- or p-hydroxybenzoic acid or p-(hydroxymethyl)benzoic acid or halobenzoic acids such as o-, m- or p-fluorobenzoic acid.

As used herein, isononanoic acid refers to one or more branched-chain aliphatic carboxylic acids with 9 carbon atoms. Embodiments of isononanoic acid used in the engine coolant composition may include 7-methyloctanoic acid (e.g., CAS Nos. 693-19-6 and 26896-18-4), 6,6-dimethylheptanoic acid (e.g., CAS No. 15898-92-7). 3,5,5-trimethylhexanoic acid (e.g., CAS No. 3302-10-1), 3,4,5-trimethylhexanoic acid, 2,5,5-trimethylhexanoic acid, 2,2,4,4-tetramethylpentanoic acid (e.g., CAS No. 3302-12-3) and combinations thereof. In a preferred embodiment, isononanoic acid has as its main component greater than 90% of one of 7-methyloctanoic acid, 6,6-dimethylheptanoic acid, 3,5,5-trimethylhexanoic acid, 3,4,5-trimethylhexanoic acid, 2,5,5-trimethylhexanoic acid, and 2,2,4,4-tetramethylpentanoic acid. The balance of the isononanoic acid may include other nine carbon carboxylic acid isomers and minor amounts of one or more contaminants. In a preferred embodiment, the isononanoic acid has as its main component greater than 90% of 3,5,5-trimethylhexanoic acid and even more preferably, the main component is greater than 95% 3,5,5-trimethylhexanoic acid.

Typical examples of dicarboxylic or tricarboxylic acids, preferably dicarboxylic acids, more preferably aliphatic dicarboxylic acids of group (E2) are malonic acid, succinic acid, glutaric acid, pimelic acid, suberic acid, azelaic acid, sebacic acid, undecanedioic acid, dodecanedioic acid, cyclopentadienedicarboxylic acid, terephthalic acid, phthalic acid and triazinetriiminocarboxylic acids such as 6,6′,6″-(1,3,5-triazine-2,4,6-triyltriimino)trihexanoic acid. Among these the aliphatic individuals are especially preferred.

The abovementioned carboxylic acids (E) are usually present entirely or predominantly as alkali metal, ammonium or substituted ammonium salts, as defined above, even when they are to have been added as free acids in the production of the antifreeze concentrate of the invention since the concentrate normally has a pH of from 4 to 11, in particular from 7 to 11, more preferably from 7 to 10, even more preferably from 7.5 to 9.5. Components (E) used as free carboxylic acids are usually converted by means of sodium or potassium hydroxide, ammonia or appropriate amines into the desired salts, preferably by means of sodium or potassium hydroxide.

In one embodiment at least one aliphatic mono- or dicarboxylic acid is present in the coolants according to the invention, more preferably at least one aliphatic dicarboxylic acid.

The interaction of the corrosion inhibitors (B) to (E) in the freezing point-lowering liquid (A) is critical to achieving the object stated at the outset. In addition, the antifreeze concentrate with corrosion protection of the invention can also comprise further corrosion inhibitors and/or other additive components, in each case individually or in mixtures and in the amounts customary for this purpose.

Further possible corrosion inhibitors (F) to (K) are:
(F) as inorganic salts, alkali metal borates, alkali metal silicates, and/or alkali metal or alkaline earth metal fluorides;
(G) aliphatic, cycloaliphatic or aromatic amines which have from 2 to 15 carbon atoms and can additionally comprise ether oxygen atoms or hydroxyl groups;
(H) monocyclic or bicyclic unsaturated or partially unsaturated heterocycles which have from 4 to 10 carbon atoms and can be benzo-fused and/or bear additional functional groups;
(J) tetra(C₁-C₈-alkoxy)silanes (tetra-C₁-C₈-alkyl orthosilicates);
(K) carboxamides or sulfonamides.

In addition to the corrosion inhibitors (B) to (K) mentioned, it is also possible to use, for example, soluble salts of magnesium with organic acids, e.g. magnesium benzenesulfonate, magnesium methanesulfonate, magnesium acetate or magnesium propionate, hydrocarbazoles or quaternized imidazoles as are described in DE-A 196 05 509 as further inhibitors in customary amounts.

Typical examples of inorganic salts (F) are sodium tetraborate (borax), sodium metasilicate, sodium nitrite, sodium nitrate, magnesium nitrate, sodium fluoride, potassium fluoride and magnesium fluoride. When alkali metal silicates and alkali metal metasilicates are concomitantly used, these are advantageously stabilized by customary organosilicophosphonates or organosilicosulfonates in customary amounts.

The amines (G) preferably have from 2 to 9, in particular from 4 to 8, carbon atoms. The amines (G) are preferably tertiary amines. The amines (G) preferably comprise from 0 to 3 ether oxygen atoms or from 0 to 3 hydroxyl groups. Typical examples of amines (G) are ethylamine, propylamine, isopropylamine, n-butylamine, isobutylamine, sec-butylamine, tert-butylamine, n-pentylamine, n-hexylamine, n-heptylamine, n-octylamine, 2-ethylhexylamine, n-nonylamine, isononylamine, di-n-propylamine, diisopropylamine, di-n-butylamine, monoethanolamine, diethanolamine and triethanolamine, monoisopropanolamine, diisopropanolamine and triisopropanolamine, piperidine, morpholine, cyclohexylamine, aniline and benzylamine. Aliphatic and cycloaliphatic amines (G) are generally saturated.

The heterocycles (H) are, in particular monocyclic five- or six-membered systems which have 1, 2 or 3 nitrogen atoms and can be benzo-fused. However, it is also possible to use bicyclic systems having five- and/or six-membered heterocyclic partial rings which typically have a total of 2, 3 or 4 nitrogen atoms. The heterocycles (H) can additionally bear functional groups such as C₁-C₄-alkoxy, optionally substituted amino or mercapto. The heterocyclic skeleton can of course also bear alkyl groups, in particular C₁-C₄-alkyl groups. Typical examples of heterocycles (H) are benzotriazole, tolutriazole (tolyltriazole), hydrogenated tolutriazole, 1H-1,2,4-triazole, benzimidazole, benzothiazole, adenine, purine, 6-methoxypurine, indole, isoindole, isoindoline, pyridine, pyrimidine, 3,4-diaminopyridine, 2-aminopyrimidine and 2-mercaptopyrimidine.

Possible silanes (J) are, for example, tetramethoxysilane, tetraethoxysilane, tetra-n-propoxysilane or tetra-n-butoxysilane.

Typical examples of the aromatic, heteroaromatic, aliphatic and cycloaliphatic (with the amide group as part of the ring) carboxamides which can be used here and of the aliphatic and aromatic sulfonamides (K) which can be used here are given in DE-A 100 36 031. As representatives of all the amides mentioned there, mention will here be made of only the following as examples: adipamide, benzamide, anthranilamide, 3- and 4-aminobenzamide, N-methyl-2-pyrrolidone, picolinamide, nicotinamide, benzenesulfonamide, o- and p-toluenesulfonamide and 2-aminobenzenesulfonamide.

Other additive components (L) to (O) can be:
(L) hard water stabilizers based on polyacrylic acid, polymaleic acid, acrylic acid-maleic acid copolymers, polyvinylpyrrolidone, polyvinylimidazole, vinylpyrrolidone-vinylimidazole copolymers and/or copolymers of unsaturated carboxylic acids and olefins; a commercially available hard water stabilizer which is suitable here is Sokalan® CP 42;
(M) antifoams;
(N) dyes;
(O) bitter substances for reasons of hygiene and safety in the case of swallowing, for example bitter substances of the type denatonium benzoate;
It is a feature of the present invention that essentially no heavy metals respectively their cations are added to the coolants on purpose. For the present invention “heavy metals” are defined as those metals which have a density of 5 g/cm³ or more. For environmental and/or toxic reasons especially essentially none of the following heavy metals is present: Copper, tin, cadmium, mercury, lead, chromium, arsenic, cadmium, manganese, cobalt, nickel, zinc, selenium, silver, antimony, molybdenum, and thallium.

For the sake of clarity the phrase “heavy metal” as used herein includes both the metallic as well as the cationic form.

Since it is possible that the constituents (A) to (O) mentioned above may contain traces of heavy metals due to their production process, the threshold for the content of heavy metals in the coolants according to the invention is 200 ppm by weight for each heavy metal, preferably the coolants do not contain more than 150, more preferably not more than 100, and especially not more than 80 ppm by weight of each heavy metal. In a preferred embodiment the content of heavy metals in the coolants for each heavy metal species is not more than 50 ppm by weight, preferably not more than 25, more preferably not more than 10, and even more preferably not more than 5 ppm by weight.

Especially for copper or manganese as heavy metals the threshold for the content in the coolants according to the invention is preferably not more than 50 ppm by weight, more preferably not more than 25, even more preferably not more than 10, and especially not more than 5 ppm by weight for each species.

It has furthermore been observed that the absence of heavy metals, especially the heavy metals mentioned above, according to the present invention yields less degradation- or oxidation-products during operation of a cooler system with a coolant according to the present invention. It has been found that less glycolic acid, oxalic acid and/or formic acid is formed compared with a similar coolant according to WO 2014/124826. Therefore, another matter of the present invention is a method for operating an internal combustion engine, electric engine, battery, or power electronics with less degradation- or oxidation-products wherein a coolant according to the present invention is used. Another matter of the present invention is a method for cooling an internal combustion engine, electric engine, battery, or power electronics wherein a coolant according to the present invention is used.

The amount of freezing point-lowering liquid (A) in the antifreeze concentrate of the invention is usually at least 75% by weight, preferably at least 80% by weight, in particular at least 85% by weight, especially at least 90% by weight, in each case based on the total amount of the concentrate.

The total amount of corrosion inhibitors (B) to (K) in the antifreeze concentrate of the invention is usually from 1 to 70% by weight, preferably from 2 to 35% by weight, in particular from 2.5 to 15% by weight, especially from 3 to 10% by weight, in each case based on the total amount of the concentrate.

The amount of the compound according to formula (I) in the antifreeze concentrate of the invention is usually from 0.01 to 5% by weight, preferably from 0.03 to 3% by weight, especially from 0.07 to 1% by weight, in each case based on the total weight of the concentrate.

The amount of inorganic nitrate salt (C) in the antifreeze concentrate of the invention is usually from 0.001 to 2% by weight, in particular from 0.003 to 1% by weight, especially from 0.007 to 0.5% by weight, in each case based on the total amount of the concentrate.

The amount of inorganic phosphate salt (D) in the antifreeze concentrate of the invention is usually from 0.1 to 8% by weight, in particular from 0.1 to 5% by weight, especially from 0.1 to 3% by weight, in each case based on the total amount of the concentrate.

The amount of aliphatic, cycloaliphatic or aromatic monocarboxylic, dicarboxylic and/or tricarboxylic acid (E) in the antifreeze concentrate of the invention is usually from 0.1 to 10% by weight, in particular from 0.5 to 8% by weight, especially from 1 to 5% by weight, in each case based on the total amount of the concentrate.

The amount of inorganic borate, silicate, and/or fluoride salt (F) in the antifreeze concentrate of the invention is usually from 0 to 2% by weight, in particular from 0.01 to 2% by weight, especially from 0.1 to 1% by weight, in each case based on the total amount of the concentrate.

The amount of aliphatic, cycloaliphatic and/or aromatic amine (G) in the antifreeze concentrate of the invention is usually from 0 to 5% by weight, in particular from 0.01 to 5% by weight, especially from 0.1 to 3% by weight, in each case based on the total amount of the concentrate.

The amount of monocyclic or bicyclic heterocycles (H) in the antifreeze concentrate of the invention is usually from 0 to 5% by weight, in particular from 0.01 to 5% by weight, especially from 0.05 to 2% by weight, in each case based on the total amount of the concentrate.

The amount of tetra(C₁-C₈-alkoxy)silane (J) in the antifreeze concentrate of the invention is usually from 0 to 5% by weight, in particular from 0.01 to 5% by weight, especially from 0.1 to 2% by weight, in each case based on the total amount of the concentrate.

The amount of carboxamide and/or sulfonamide (K) in the antifreeze concentrate of the invention is usually from 0 to 10% by weight, in particular from 0.01 to 10% by weight, especially from 0.1 to 5% by weight, in each case based on the total amount of the concentrate.

The amount of hard water stabilizers (L) in the antifreeze concentrate of the invention is usually from 0 to 1% by weight, in particular from 0.01 to 1% by weight, especially from 0.05 to 0.5% by weight, in each case based on the total amount of the concentrate.

The amount of antifoam (M) in the antifreeze concentrate of the invention is usually from 0 to 0.5% by weight, in particular from 0.0005 to 0.05% by weight, especially from 0.001 to 0.02% by weight, in each case based on the total amount of the concentrate.

The amount of dye (N) in the antifreeze concentrate of the invention is usually from 0 to 0.05% by weight, in particular from 0.001 to 0.05% by weight, in each case based on the total amount of the concentrate.

The amount of bitter substance (O) in the antifreeze concentrate of the invention is usually from 0 to 0.05% by weight, in particular from 0.001 to 0.05% by weight, in each case based on the total amount of concentrate.

The antifreeze concentrate of the invention can additionally comprise small amounts of water, usually from 0 to 10% by weight, in particular from 0 to 5% by weight, in each case based on the total amount of the concentrate.

The total amount of all components comprised in the antifreeze concentrate of the invention (including the water) is in all cases 100.0% by weight.

In a preferred embodiment, the antifreeze concentrate of the invention comprises from 75 to 99.5% by weight of the freezing point-lowering liquid (A), a total of from 0.5 to 25% by weight of the corrosion inhibitors (B) to (E) (in sum), from 0 to 10% by weight of further corrosion inhibitors which are different from (B) to (E) and are normally selected from the abovementioned groups (F) to (K) and also from 0 to 10% by weight of water.

The antifreeze concentrate of the invention can be produced by simple mixing of the individual components. However, the antifreeze concentrate of the invention can also be produced by dilution of an appropriate superconcentrate in which the active components (B) to (O) are present in higher concentration with the freezing point-lowering liquid (A) functioning as antifreeze component and optionally some water. The proportion of the superconcentrate in the concentrate is generally from 3 to 60% by weight.

Superconcentrates are, usually for transport purposes, produced from concentrates having a normal concentration by withdrawal of such an amount of antifreeze component that the further constituents are still just present in dissolved form.

The present invention also provides an aqueous coolant composition comprising from 10 to 90% by weight, in particular from 20 to 60% by weight, of the antifreeze concentrate of the invention. The aqueous coolant composition of the invention is usually produced from the antifreeze concentrate of the invention by dilution with the appropriate amount of water.

Therefore, the content of the components (A) to (O) given above for the concentrates can easily calculated for the aqueous coolant compositions according to the invention by taking into account the dilution with water.

The present patent application further provides for the use of the abovementioned aqueous coolant composition of the invention for cooling an internal combustion engine, electric engine, battery, or power electronics whose cooling apparatus has been made predominantly or solely of aluminum using a soldering process using a fluoroaluminate flux. In this way, the problem of precipitation of aluminum hydroxide gels and formation of sludge in the cooling circuit in such cooling apparatuses, as indicated at the outset, is solved in a very advantageous way. The aqueous coolant composition of the invention thus has a significantly higher tolerance to residues of fluoroaluminate fluxes and as a result provides more effective corrosion protection. The coolants according to the present invention especially fulfil the requirements of corrosion protection for passenger cars, preferably against corrosion of iron, iron alloys, copper, brass, aluminum, and especially against corrosion of aluminum, steel, and copper.

A series of the abovementioned sulfur-comprising organic compounds (B) are also generally suitable as extraordinarily effective corrosion inhibitors in antifreeze concentrates, even in cooling apparatuses and heat transfer circuits which do not contain any aluminum radiators soldered using fluoroaluminate fluxes. The present invention therefore also provides for the use of (2-benzothiazylthio) acetic acid, 3-(2-benzothiazylthio) propionic acid, (thiobenzoylthio) acetic acid, and their alkali metal, ammonium and substituted ammonium salts as corrosion inhibitors in antifreeze concentrates based on freezing point-lowering liquids selected from among monovalent, divalent and trivalent alcohols, polyhydroxy alcohols, their ethers and mixtures thereof as main constituent and in aqueous coolant compositions produced therefrom.

While the coolants according to the invention are suitable for cooling internal combustion engines, electric engines, batteries, and power electronics in all kinds of mobile or stationary applications, they are preferably used in vehicles of all kinds and more preferably in passenger cars.

The following examples illustrate the present invention without restricting it.

### EXAMPLES

TABLE 1
Compositions

| | Compositions 1 and | Composition 2 |
|---|---|---|
| Weight % | 3 (comparative (1)) | (invention) |
| Mono Ethylene Glycol | 90.90 | 89.26 |
| Potassium Hydroxide (KOH) | 4.15 | 5.2 |
| Sebacid Acid | 3.00 | 4.2 |
| Isononanoic Acid | 0.60 | — |
| Tolutriazol | 0.15 | 0.15 |
| Sodium Nitrate | — | 0.33 |
| (2-Benzothiazylthio)acetic Acid | 0.15 | 0.30 |
| Phosphoric Acid | 0.15 | 0.25 |
| Sodium Molybdate Dihydrate | 0.20 | — |
| Sodium meta silicate penta hydrate | 0.43 | — |
| Other Additives (2) | Balance to 100 | Balance to 100 |
| | wt % | wt % |

(1) Comparative according to WO 2014/124826 A1, Example KM3
(2) Hard water stabiliser, colorant, defoamer, etc.

### Influence of Molybdenum on Oxidation Stability of Coolants (Ranzimat Test)

20 g of the coolant Compositions 1 and 2 according to Table 1 and Composition 1 without molybdenum were placed in a Ranzimat apparatus. Air (10 l/h) was led through the composition at 130° C. for 24 hours (DIN EN 15751:2014-06).

The compositions before and after the test were analysed by gas chromatography for the oxidation products formic acid, acetic acid, and glycolic acid, and pH-value and reserve alkalinity (mL HCl 0.1 mol/L) were determined:

TABLE 2

| | | Reserve | | | |
|---|---|---|---|---|---|
| | | Alkalinity | | | |
| | pH- | [mL HCl 0.1 | Formiate | Acetate | Glykolate |
| | Value | mol/L] | [ppm] | [ppm] | [ppm] |
| Composition 1 | 8.4 | 10.0 | 144 | <10 | <10 |
| before test | | | | | |
| Composition 1 | 9.5 | 10.7 | 362 | 52 | 1238 |
| after test | | | | | |
| Composition 1 | 8.6 | 10.4 | <10 | <10 | <10 |
| without Mo | | | | | |
| before test | | | | | |
| Composition 1 | 10.2 | 12.3 | 189 | 15 | 163 |
| without Mo | | | | | |
| after test | | | | | |
| Composition 2 | 7.4 | 9.5 | <10 | <10 | <10 |
| before test | | | | | |
| Composition 2 | 9.7 | 13.5 | 197 | 22 | 326 |
| after test | | | | | |

It can easily be seen that the presence of molybdenum in Composition 1 leads to increased amounts of carboxylic acids which demonstrates the oxidative potential molybdenum exhibits in the presence of air.

Carboxylic acids are formed much less in the absence of molybdenum in Composition 1 without molybdenum and Composition 2.

### Corrosion Test According to ASTM D4340

The compositions according to Table 1 were diluted with 50 vol % bi-distilled water, optionally 500 ppm flux KₓA_{y}lF_{z} was added.

Corrosion test according to ASTM D4340 (standard coupon GAlSi6Cu4, corrosion rate given in mg/cm²) was conducted and pH-value and reserve alkalinity (mL HCl 0.1 mol/L) before and after the test were determined.

TABLE 3

| | Corrosion | | | Reserve | Reserve |
|---|---|---|---|---|---|
| | rate | pH-value | pH-value | Alkalinity | Alkalinity |
| | (mg/cm²) | before test | after test | before test | after test |
| Composition | −0.068 | 8.6 | 8.1 | 5.2 | 5.3 |
| 3 | | | | | |
| Composition | −0.080 | 8.6 | 7.8 | 5.2 | 5.1 |
| 3 + Flux | | | | | |
| Composition | 0.089 | 6.8 | 6.9 | 5.0 | 5.3 |
| 2 | | | | | |
| Composition | 0.066 | 6.8 | 6.9 | 4.9 | 5.0 |
| 2 + Flux | | | | | |

It can easily be seen that Composition 2 according to the invention exhibits a similar corrosion rate as Composition 3 according to WO 2014/124826 A1 despite the absence of molybdenum as corrosion inhibitor and a good tolerance even in the presence of Flux.

The pH-value changes even less in Composition 2 than in Composition 3, while the reserve alkalinities are comparable.

1. An antifreeze concentrate with corrosion protection, comprising:
(A) at least one freezing point-lowering liquid selected from the group consisting of monohydric, dihydric and trihydric alcohols, polyhydroxy alcohols, their ethers and mixtures thereof as main constituent;
(B) at least one 2-thiothiazole of the general formula I 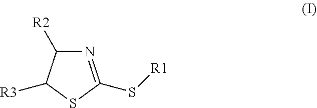
where the variable R1 is hydrogen or a carboxyalkyl radical of the formula —(CₘH₂ₘ)—COOX, where m is from 1 to 4 and X is hydrogen, an alkali metal cation, an ammonium cation or a substituted ammonium cation, and the variables R2 and R3 are each, independently of one another, hydrogen or a C₁-C₄-alkyl group, where R2 and R3 together with the two ring carbon atoms of the thiazole ring to which they are attached may also form a five- or six-membered saturated or unsaturated ring as corrosion inhibitor;
(C) at least one inorganic nitrate salt as further corrosion inhibitor;
(D) at least one inorganic phosphate salt as further corrosion inhibitor;
(E) at least one aliphatic, cycloaliphatic or aromatic monocarboxylic, dicarboxylic or tricarboxylic acid in the form of alkali metal, ammonium or substituted ammonium salts thereof having from 3 to 21 carbon atoms in the acid part,
with the proviso that metals having a density of 5 g/cm³ or more in metallic or cationic form are present in the concentrate in amounts of not more than 200 ppm by weight for each metal,
wherein component (B) is (2-benzothiazylthio) acetic acid, 3-(2-benzothiazylthio) propionic acid or an alkali metal, ammonium or substituted ammonium salt thereof.

2. The antifreeze concentrate according to claim 1, wherein component (A) is selected from the group consisting of monoethylene glycol, monopropylene glycol and mixtures of monoethylene glycol or monopropylene glycol with up to 35% by weight of glycerol.

3. The antifreeze concentrate according to claim 1, wherein component (C) is selected from the group consisting of (earth) alkali metal, ammonium and substituted ammonium salts of nitric acid (HNO₃).

4. The antifreeze concentrate according to claim 1, wherein component (E) comprises at least one aliphatic monocarboxylic acid.

5. The antifreeze concentrate according to claim 1, wherein component (E) comprises at least one aliphatic dicarboxylic acid.

6. The antifreeze concentrate according to claim 1, wherein the metals are selected from the group consisting of copper, tin, cadmium, mercury, lead, chromium, arsenic, cadmium, manganese, cobalt, nickel, zinc, selenium, silver, antimony, molybdenum, and thallium.

7. The antifreeze concentrate according to claim 1, comprising:
from 75 to 99.5% by weight of the freezing point-lowering liquid (A),
from 0.5 to 25% by weight of the corrosion inhibitors (B) to (E) (in sum),
from 0 to 10% by weight of further corrosion inhibitors which are different from (B) to (E), and
from 0 to 10% by weight of water,
with the proviso the sum is always 100%.

8. An aqueous coolant composition, comprising from 10 to 90% by weight of the antifreeze concentrate according to claim 1, and water to the balance.

9. A method, comprising:
producing the aqueous coolant composition according to claim 8,
wherein the antifreeze concentrate is diluted with water.

10. A method, comprising:
cooling an internal combustion engine, electric engine, battery, or power electronics in mobile or stationary applications, wherein the aqueous coolant composition according to claim 8 acts as coolant.

11. A method, comprising:
cooling an internal combustion engine, electric engine, battery, or power electronics whose cooling apparatus has been made predominantly or solely of aluminum using a soldering process using a fluoroaluminate flux wherein the aqueous coolant composition according to claim 8 acts as coolant.

12. A method, comprising:
operating an internal combustion engine, electric engine, battery, or power electronics wherein a coolant according to claim 1 acts as coolant.

13. The method for operating an internal combustion engine, electric engine, battery, or power electronics according to claim 12, comprising cooling with the coolant in a cooling apparatus, or cooling circuit made predominantly or solely of aluminum or aluminum alloys.

14. The method for operating an internal combustion engine, electric engine, battery, or power electronics according to claim 13, wherein the cooling apparatus or cooling circuit made is obtained from a soldering process using potassium fluoroaluminates containing flux.

15. A method, comprising:
cooling an internal combustion engine, electric engine, battery, or power electronics wherein a coolant according to claim 1 acts as coolant.

16. The antifreeze concentrate according to claim 1, with the proviso that the metals having a density of 5 g/cm³ or more in metallic or cationic form are present in the concentrate in amounts of not more than 80 ppm by weight for each metal.

17. The antifreeze concentrate according to claim 2, wherein component (A) is monoethylene glycol.

18. The antifreeze concentrate according to claim 3, wherein component (C) is sodium nitrate or potassium nitrate.

19. The antifreeze concentrate according to claim 4, wherein component (E) comprises at least one aliphatic monocarboxylic acid selected from the group consisting of propionic acid, pentanoic acid, hexanoic acid, octanoic acid, 2-ethylhexanoic acid, nonanoic acid, isononanoic acid, decanoic acid, neodecanoic acid, undecanoic acid, and dodecanoic acid.

20. The antifreeze concentrate according to claim 5, wherein component (E) comprises at least one aliphatic dicarboxylic acid selected from the group consisting of malonic acid, succinic acid, glutaric acid, pimelic acid, suberic acid, azelaic acid, sebacic acid, undecanedioic acid, and dodecanedioic acid.
